(19) United States
(12) Patent Application Publication
(10) Pub. No.: US 2017/0040811 A1
(43) Pub. Date: Feb. 9, 2017

(54) APPARATUS AND METHOD FOR AN ENHANCED SMART BADGE CHARGER

(71) Applicants: JOSEPH ERNEST DRYER, HOUSTON, TX (US); JOHN DAVID LAMBERT, KATY, TX (US)

(72) Inventors: JOSEPH ERNEST DRYER, HOUSTON, TX (US); JOHN DAVID LAMBERT, KATY, TX (US)

(21) Appl. No.: 14/816,140

(22) Filed: Aug. 3, 2015

(51) Int. Cl. H02J 7/00; H02J 7/02; G06K 7/10; H02J 7/35

(52) U.S. Cl. CPC H02J 7/0044; H02J 7/35; H02J 7/025; G06K 7/10009

(57) ABSTRACT

A method and apparatus for the temporary storage of multiple smart badges for charging of the smart badge energy storage means. During charging the method and apparatus exchanges data with each smart badge and prepares the smart badge data for communication over a data link to an external system by accumulating, processing, augmenting, delaying and reformatting the information. A further enhancement of the method and apparatus is the sanitation of smart badges stored in the enclosure. A further enhancement of the method and apparatus is the authentication of users seeking to retrieve stored smart badges and by several means restricting, alarming or prohibiting the retrieval of any smart badge not associated with an identified individual.

### CROSS-REFERENCE TO RELATED APPLICATIONS

none

### FEDERALLY SPONSORED RESEARCH

None.

### SEQUENCE LISTING

None.

### BACKGROUND

Prior Art

The following is a tabulation of some prior art that presently appears relevant: U.S. Patents

| Patent Number | Issue Date | Patentee |
|---|---|---|
| 9,076,091 | Jul. 7, 2015 | Mincey, et al. |
| 9,047,755 | Jun. 2, 2015 | Bonner |
| 9,041,511 | May 26, 2015 | Velez, et al |
| 8,983,373 | Mar. 17, 2015 | Buczek |
| 8,547,220 | Oct. 1, 2013 | Dempsey, et al |
| 8,164,439 | Apr. 24, 2012 | Dempsey, et al |
| 8,541,983 | Sep. 24, 2013 | Veselic, et al |
| 7,999,514 | Aug. 16, 2011 | Veselic, et al |
| 7,906,940 | Mar. 15, 2011 | Veselic, et al |
| 7,847,520 | Dec. 7, 2010 | Veselic, et al |
| 7,791,319 | Sep. 7, 2010 | Veselic, et al |
| 8,963,723 | Feb. 24, 2015 | Snodgrass |
| 8,674,840 | Mar. 18, 2014 | Snodgrass |
| 8,633,816 | Jan. 21, 2014 | Snodgrass, et al |
| 8,544,753 | Oct. 1, 2013 | Antebi, et al |
| 8,471,706 | Jun. 25, 2013 | Schuster, et al |
| 8,439,263 | May 14, 2013 | Clark, et al |
| 8,373,383 | Feb. 12, 2013 | Dandekar, et al |
| 8,287,380 | Oct. 16, 2012 | Nguyen, et al |
| 8,237,558 | Aug. 7, 2012 | Momen, et al |
| 8,152,071 | Apr. 10, 2012 | Doherty, et al |
| 7,966,008 | Jun. 21, 2011 | Graves, et al |
| 7,898,407 | Mar. 1, 2011 | Hufton, et al |
| 7,801,743 | Sep. 21, 2010 | Graves, et al |
| 7,707,044 | Apr. 27, 2010 | Graves, et al |
| 7,741,808 | Jun. 22, 2010 | Fowler, et al |
| 7,714,723 | May 11, 2010 | Fowler, et al |
| 7,710,251 | May 4, 2010 | Talty, et al |
| 7,683,770 | Mar. 23, 2010 | Talty, et al |
| 7,136,379 | Nov. 14, 2006 | Woods, et al |
| 5,434,396 | Jul. 18, 1995 | Owen, et al |

### U.S. PATENT APPLICATION PUBLICATIONS

| Publication Nr. | Publ. Date | Applicant |
|---|---|---|
| 20150170501 | Jun. 18, 2015 | MUKHERJI; et al |
| 20140292518 | Oct. 2, 2014 | Wildman;. et al |
| 20050134581 | Jun. 23, 2005 | Hawkins et al |

### BACKGROUND

In this discussion the term “smart badge” will be employed to mean a wearable badge with an embedded microchip that can be loaded with data. In this discussion the term “enclosure” will be employed to describe an apparatus for mounting smart badges so that the smart badges are accessible to a means to download and upload data and at the same time are capable of being supplied with energy to enable the renewal of any means of energy storage. “Providing an enclosure” will be employed to describe the operation of providing such an enclosure. The machine that is the subject of this invention will be referred to as the “comprehensive charger”.

There have been a number of patents and patent applications utilizing smart badges in employee monitoring and hand sanitation monitoring. Some such U.S. patents and applications are: Ser. No. 14/305,236 by Mukherji et al, Ser. No. 14/302,821 by Wildman et al, U.S. Pat. No. 8,674,840 by Snodgrass, U.S. Pat. No. 8,633,816 by Snodgrass et al, U.S. Pat. No. 8,963,723 by snodgrass, U.S. Pat. No. 9,047,755 by Bonner, U.S. Pat. No. 7,898,407 by Hufton et al, and U.S. Pat. No. 8,237,558 by Momen. Most have a wireless interface or utilize badge alerts to report in real-time the sanitation status of the badge wearer. In practical cases there is a need for accountability but not a need for remote reporting of real-time accountability. It is better to counsel employees about a pattern of bad practices rather than have supervisors attempting to counsel immediate behavior, and employee reviews are generally not in real time. Examples are nurses or food servers workers working in the middle of the night where tasks are immediate and supervisors are few. Additionally, the provision of real-time monitoring requires often the provision of wireless interface over the entire area of activity, which could include most of an entire hospital, and provisions for a central control coordinating reporting stations.

There are many examples of recharging stations for smart badges (e.g. http://www.stanleyhealthcare.com/sites/stanleyhealthcare.com/files/documents/T14%20Charging%20Station%20Date%20Sheet.pdf) and examples where the communications port of the charged device is made externally available (e.g. U.S. Pat. No. 8,547,220, FIG. 20). There is a notable lack of the functions to be described for a small, inexpensive communications controller within a multiple charging station which can accumulate smart badge information, process, reformat, delay and communicate to other media, e.g. to act as a smart interface between the data in smart badges, which are residing unused during charging, and a secure remote server. Including such a smart interface accomplishes far more than allowing external direct access to each charging smart badge. Embedding the protocol for secure communications within the smart badge itself unnecessarily complicates the design of the smart badge and prevents the use of the most simple data interfaces, such as a 1-wire interface (https://en.wikipedia.org/wiki/1-Wire).

There has been a limited discussion of a structure like the comprehensive badge charger. There are a number of discussions of charging systems that have provided data access by transmitting a data bus, buffered or unbuffered, from the mobile device through the charging cradle or charging enclosure. This does not provide the functions of the communications controller (150 in FIG. 1) such as data accumulation, re-formatting and transmission in a different format to a different media at a different time. The use of an integrated communications controller greatly reduces cost, minimizes conflicts and allows for greater flexibility in smart badge interface. The simplicity available in the functionality of the separate communications controller allows implementation in a single microprocessor and allows simplified programming of this simple system, There is also a simplification in the design of the smart badge in that a simplified, short-distance protocol inappropriate for outside communications can be used. There are communications protocols supported in many inexpensive microcontrollers which can be implemented for short distance simple data transfer with simple coding. Some examples of data access by transmitting a data bus, buffered or unbuffered, from the mobile device through the charging cradle or charging enclosure are U.S. Pat. No. 8,547,220 by Dempsey et al, U.S. Pat. No. 8,164,439 by Dempsey, et al, U.S. Pat. No. 8,547,220 by Dempsey, et al, Veselic, et al, Woods et al, U.S. Pat. No. 8,544,753 by Antebi et al, U.S. Pat. No. 8,439,263 by Clark et al (which does not describe the charging of multiple units), U.S. Pat. No. 8,373,383 by Dandekar, et al (which also charges large items with no mention of a cradle), U.S. Pat. No. 8,152,071 by Doherty, et al (a docking system for a computer), U.S. Pat. No. 5,434,396 by Owen, et al (has a means of coupling data and power inductively to a single stand-alone device is discussed but contains no provision for multiple stand-alone devices or multiple cradles).

Some discussions of the use of RFID readers have emphasized that such readers can provide power during data reads. This is useful for identification while the smart badge is in use but is less useful for downloads of smart badge information during the inoperable time a smart badge is in a charger which ensures full charging even if the smart has not been read. Additionally, the functionality of the communications controller (150 in FIG. 1) such as data accumulation, re-formatting and transmission in a different format to a different media at a different time is missing in an RFID reader. Examples of such RFID readers are Mincey et al, U.S. Pat. No. 7,710,251 by Talty et al, and U.S. Pat. No. 7,683,770 by Talty et al.

U.S. Pat. No. 8,471,706 by Schuster et al deals with RFID tags for automobile keys and personnel tags and states there may be a charger that reads the identity of the RFID when the tag is in the charger. There is no discussion of downloading to the charger any information other than ID and no discussion of any of the functions of the communications controller (150 in FIG. 1) such as data accumulation, re-formatting and transmission in a different media at a different time. U.S. Pat. No. 8,983,373 by Buczek is a system for a single mobile device that has one mode of operation when in a charging cradle and another mode of operation when operating in a holster. The cradle is for a single device, not multiple cradles, in a holster, and there is no discussion of any of the functions of the communications controller (150 in FIG. 1) such as data accumulation, re-formatting and transmission in a different media at a different time. U.S. Pat. No. 8,287,380 by Nguyen, et al discusses docking stations for VCARD charging, where VCARDs are described as a “handheld display device” whereas a smart badge is not handheld. U.S. Pat. No. 7,966,008 by Graves et al, U.S. Pat. No. 7,801,743 by Graves et al, and U.S. Pat. No. 7,707,044 by Graves et al describe communication with the mobile device while outside the charging station. There is no discussion of communication to the mobile device while inside the charging station to download, modify and consolidate data contained in the mobile device. U.S. Pat. No. 7,741,808 by Fowler et al, and U.S. Pat. No. 7,714,723 by Fowler et al discusses a media-enhanced shopping cart with charger. There is no ability for multiple smart badge units in cradles.

U.S. Pat. No. 9,041,511 by Velez et al is a patent describing a docking station to perform a different function, using the docked “mobile device” to communicate the mobile device's owner's authentication and location. “Implementations described herein relate to identifying an employee's location based on a location of his/her mobile device.” The mobile device is any “type of digital computing device that has the capability to communicate via one or more networks”. With the comprehensive charger a discussion of “authorization” involves the external authorization of a user attempting to retrieve a smart badge, while Velez uses the term to describe the badge as a form of authorization. The communication interface (Velez FIG. 2 270) has no definitive function but “may include a transceiver for communicating with network 140”. A “transceiver” relays a message and does not modify the data itself, consistent with the use of a mobile device requiring network connectivity and the bridging device (Velez FIG. 2 240). The current invention rejects the requirement that the mobile device (smart badge) have network connectivity, and this feature would eliminate the simplest and least expensive smart badge implementation. In the current invention there is no means of direct communication between the mobile device (smart badge) and the outside world and all data transfer between the smart badge is through the communications controller (150 in FIG. 1) which modifies any information received from the smart badge by reformatting, accumulating, framing, all functions which have no analog in Velez.

### SUMMARY

The use of smart badges involves the ability to recharge the power sources in the smart badge. While the smart badge is not being used while in the charger there is also opportunity to collect data from the smart badge and massage this data for delivery to the outside world. It is often useful to associate an individual with the smart badge and prevent the misappropriation of the smart badge identity when retrieved from a charger. In many industries the sanitization of a badge to prevent spread of contamination is desirous. These requirements are often met by separate systems, if at all, but there are advantages to combine these functions in a single unit, which is the subject of this invention. The combination gives advantages in reduced system cost and complexity, easier installation and site preparation, and greater assurance that all functions are performed.

### FIGURES

FIG. 1 illustrates the essential features of the comprehensive charger.

FIG. 2 illustrates the preferred embodiment.

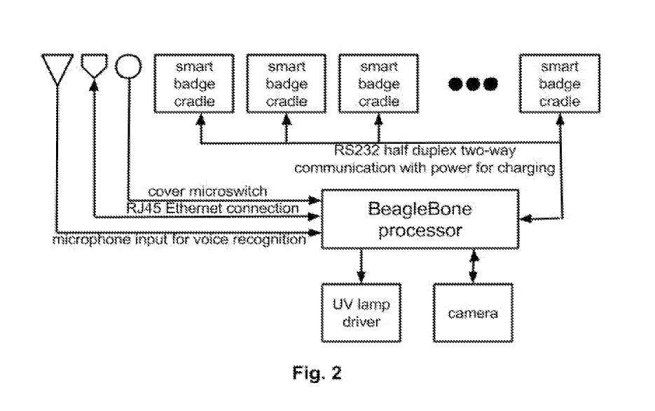

### DETAILED DESCRIPTION

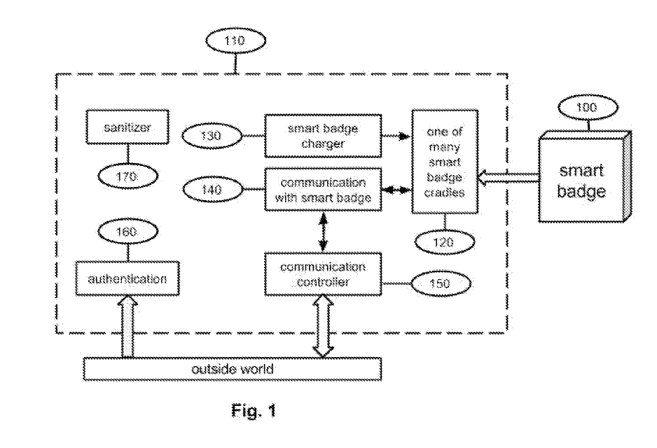

FIG. 1 shows the features of this invention herein referred to as a “comprehensive charger”. Multiple smart badges 100 are placed in an enclosure 110 containing the elements of the comprehensive charger. Inside or through this enclosure each of the smart badge are placed in a cradle 120 to separate the smart badges and allow for each smart badge a connection to a charger 130 and to a communications means 140. There are a number of possible means for the charger to transfer energy to the smart badge in the cradle depending on the design of the smart badge. Some possibilities are inductive charging, charging through contacts on the smart badge or the exposure of a photovoltaic cell on the smart badge to a charging light provided by the charger. There are also a number of possible means of communications with a smart badge: wireless communication such as WiFi, BlueTooth, ZigBee, etc., communication through contacts on the smart badge, visual or infrared light links, and other similar communication links. As communication is to be only between the communications controller 150 and each smart badge 100, the communications means in 140 can be selected for minimum cost. This allows recharging of the battery or other energy storage device within each smart badge while information within the smart badge is downloaded and any necessary updates are uploaded to the smart badge. Typical of information downloaded from the smart badge in the case of a hand wash monitoring smart badge would be the amount of time the wearer was in a contaminated state, the maximum time the wearer was continually in a contaminated state and the number and times the wearer washed their hands. Also uploaded might be the status of the smart badge such as any restarts and abnormal battery discharges. Typical data to be uploaded to the smart badge would include programmatic upgrades and time synchronization of the clock in the smart badge. Data to and from the smart badge is controlled by a communications controller 150 which is a processor unit that can perform the functions of controlling what data, when and with what format communication with the smart badge is conducted. For example if smart badge status information indicates the smart badge is in need of updates to its program, such updates can be communicated in a secure form to the smart badge by the program in the communications controller 150. The embedded communications controller 150 allows a choice of the least expensive physical connection to the smart badge, the most easily implemented communications protocol while shielding the smart badge from security threats from the outside world. For example, 1-Wire, SPI and RS232 full and half duplex are communications protocols supported in many inexpensive microcontrollers which can be implemented for simple data transfer with simple coding. The communications between the communication controller 150 and the smart badge 100 should not be a derivative of the Ethernet protocol as this would unnecessarily increase the expense of the smart badge and the smart badge should have no communication with the outside world while in the comprehensive charger other than through total control by the communications controller 150. The communications controller 150 also provides a separate, independent communication link to other systems in the outside world. Possible outside communications links could include, for example, communications to a server on the Internet, communications to a local computer or communications to a data storage device or monitor camera. The communications controller 150 selects the information to transmit, which could include all or some of the data uploaded from each smart badge, the processed data from all smart badges information from other elements of the enclosure such as authentication information about a user attempting to gain access, or the status of past communication links, the cradle ID of a smart badge, communications with external devices such as cameras, and the communication of its own status for preemptive maintenance. The communications controller could delay or batch such communications. The communications controller 150 formats transmissions to the outside world in a manner appropriate for the destination and type of communication and does not simply act as a transceiver between the outside world and the smart badge 100. One function of the communications controller 150 is the spooling of communications to the outside world in cases where the communications channel is down for later transmission when the communications channel goes back up. There are often situations where a smart badge needs to be initialized in a particular manner when first removed from the comprehensive charger. For instance for food handlers or health care workers at the start of a shift hands should be washed before any tasks are attempted. If the smart badge indicates the state of the workers sanitation (hands possibly contaminated) then the communication controller can initialize the smart badge to the contaminated state before removal from the comprehensive charger.

There are some considerations that may be incorporated into the comprehensive charger in order to satisfy additional requirements. One issue arises in cases where a smart badge is assigned to an individual and there are consequences if other parties either mistakenly or on purpose take the smart badge from the comprehensive charger. This can be addressed by a unit referred to in FIG. 1 as the authentication unit 160. The function of this unit is to provide to the communications controller 150 identification information from the outside world of any user attempting to remove a smart badge from the comprehensive charger. Some of the many possible means of identification of a user by the authentication unit 160 that could be employed are: code input from a keyboard, voice recognition, facial recognition from a camera, biometric identification, RFID authentication, etc. Once an individual is identified some possible results are: sound an alarm or alert if an incorrect smart badge is removed, indicate which smart badge is to be removed and lock all other smart badges into their cradle, or record the individual identity and allow the incorrect smart badge to be removed while recording the incident for possible transmission. Although if all smart badges are fungible if there is no need to associate an individual smart badge with a particular individual, another possibility for the communication controller to associate any smart badge removed with the identified individual for all information subsequently gathered from the smart badge. This association could include downloading the name or other identification which can be displayed on the smart badge. Another possibility would be to record a picture, time-stamped and showing a smart badge ID, whenever a smart badge is removed from the comprehensive charger. The combination of authentication by authentication unit 160 and smart badge removal or return can be utilized in other ways. For example, the removal of a smart badge can be used as the timestamp of the wearer's start of a shift and the return of the smart badge as the timestamp of the end of the shift.

An additional problem with the use of smart badges in healthcare and food preparation is the possibility that the smart badge becomes contaminated or infected during use. It is desirable that smart badges be disinfected to prevent cross-contamination. This can be accomplished in the comprehensive charger by providing a sanitizer 170 shown if FIG. 1. The purpose of this unit is to provide in a safe manner the desired sanitization to smart badges during recharging. Because the recharge time is long compared to normal sanitize time a lower level of sanitization over the longer period is as effective, and the enclosure 110 of FIG. 1 could be closed to limit exposure of the sanitizer to the environment. Some of the possible means of sanitization are: ultraviolet light, where any ozone created can be used for further sanitization and not vented; sanitizer liquid or vapor, possibly enhanced by ultrasonic agitation, where the sanitizer may be removed by movement of the cradle 120 and possible air blast before smart badge removal to limit user exposure. An additional advantage of potential user identification or recognition is the ability for smart badge removal or reinsertion without the user touching any surface of the comprehensive charger by automatic, non-contact exposure of the smart badge cradles only on the identification or recognition of a user. This, combined with the sanitization, would limit contamination possibilities where a smart badge or comprehensive charger is contaminated by touch of a user and avoid or limit exposure of the sanitizing means to the environment.

The use of smart badges to monitor employee hand sanitation, such as the system of U.S. Pat. No. 7,898,407 entails several features: (herein referred to as “the essential features”).
1. The smart badge contains electronics which consume power. This power is normally supplied, even if in a backup mode, by a battery which needs to be recharged periodically to maintain functionality.
2. The smart badge may be used anonymously, where the user of the smart badge is not identified, and any user can use any smart badge, or is used by a particular identified individual. The choice can depend on circumstances and the same system may be used in either mode.
3. The communication between the smart badge and beacons to indicate when the smart badge is contaminated or decontaminated can require one-way communication to the smart badge while any real-time report by the smart badge of its status to a central control requires two-way communication and central coordination. In such a case a facility must be wired for such communication to and from all badges and all beacons.
4. Often real-time notification of a status is not necessary as it interferes with on-going operations and the desired outcome is development of a constant awareness of compliance and development of long-term training and statistical improvement.
5. Smart badges are often misplaced or taken home and consequently are unavailable.
6. Smart badges in a charging station are often retrieved by the wrong user, either accidentally or deliberately.
7. A smart badge, especially with exposure to health care and food-borne infections, can become contaminated and require periodic disinfection.

It is the intention of the current invention to provide a means whereby behavioral information can be accumulated in a smart badge and while the smart badge is in a comprehensive recharging station data can be downloaded from the smart badge, accumulated and uploaded to a remote station in a mutually agreeable format. Such a system addresses “the essential features above” as follows:
1. Since all functions of the comprehensive recharge station are accomplished while the smart badge is being recharged, recharging is performed, and if the battery level before and after recharging can be reported as part of the smart badge download, battery health can be monitored.
2. The smart badge is tagged and if the smart badge is not assigned to a particular individual then the smart badge use is anonymous. This is used when data is to be accumulated and identification is not required. Non-anonymous use requires identification of a particular smart badge with a particular user, either at the time of removal from the comprehensive charger, by limiting smart badge access to associated, authenticated users or by the association of a user removing a smart badge with the smart badge being removed by appropriate downloading to the smart badge by the comprehensive charger.
3. In simplified systems the smart badge can be triggered one-way from beacons so the smart badge stores a record of locations visited with the time of visits and during subsequent storage in the comprehensive charger the record of the smart badge activities can be downloaded to a local processing system in the communication controller 150 to be possibly accumulated and reformatted and then transferred by a separate communications link from the comprehensive charger to a remote server for subsequent use. There is no need for wiring an entire facility to accommodate two-way communication with each smart badge, no need for sophisticated communications capability in each smart badge, and no need for a centralized control outside the comprehensive charger. For many systems this could dramatically reduce cost.
4. The use of a comprehensive charger can act as a local accumulator of data for one day or one shift. All data can be time-stamped in the smart badge and browser review and report generation accomplished after accumulation in a secure central server location. Any real-time information, e.g. exposure to a contamination, can be best displayed on the smart badge rather than a remote terminal, often allowing immediate user notification or correction by peer pressure from co-workers even during active times when real-time remote reporting would not be timely responded to.
5. The retrieval of a smart badge from a comprehensive charger can be used as an indication of the start of a shift and the return of a smart badge to the comprehensive charger used as an indication of the end of a shift as these events are time-stamped by the comprehensive charger. The duplication of smart badges or past user of a missing smart badge can be identified on the remote server. This tying of employee performance measurement to the proper treatment of smart badges provides an incentive to encourage proper treatment of the smart badges.
6. Access to the comprehensive charger can be limited by such authorization as biometric identification or keyboard password entry, and various means of treating or preventing improper smart badge retrieval can be implemented as discussed previously. Alternatively smart badges can be associated by the comprehensive charger with an authorized user and be henceforth identified with the authorized user.
7. The comprehensive charger can incorporate a mechanism for the disinfecting of a smart badge during charging. This can be accomplished by exposing the smart badge to disinfecting liquid or disinfecting ultraviolet radiation while the smart badges are undergoing the charging. The design of the comprehensive charger can limit the exposure of users to excessive chemical or radiation.

It can be seen that a system such as the comprehensive charger addresses many of the problems encountered in the use of smart badges. The combination of these features within a single enclosure will reduce cost and enhance functionality.

### PREFERRED IMPLEMENTATION

As one implementation of the concept of the comprehensive charger, a processor with internet capabilities, such as the BeagleBone Black™ is utilized as the communications controller 150. This is mounted in a metal enclosure 110 with a cover containing slots into which the smart badges are inserted. Pockets in the slots which provide contacts for RS-232 connections to the smart badges represent the smart badge cradles 120. The power connections on the RS-232 connections provide power to recharge each smart badge battery and the communication channels provide multi-drop half duplex communication to any smart badge that is inserted. A removable cover with a micro switch position indicator connected to the BeagleBone must be removed to access the smart badges in the cradles, giving notice that the smart badges are being accessed. A RS-232 port on the BeagleBone is the master for the half duplex multi drop connections to the smart badges. When the BeagleBone transmits a global polling call each mounted smart badge delays an assigned period before responding with its ID. This avoids collisions and allows an interrogation of which units are connected. When the lid is removed the BeagleBone goes into a continuous polling mode to determine which smart badges are being added or removed and a record of this event is made. Pertinent information is exchanged with each identified smart badge and accumulated and summarized in the BeagleBone which has wired RJ-45 Internet connection to a remote secure central server for user interface via a browser. When the lid is returned each mounted smart badge is bathed in ultraviolet light to provide disinfection. When the lid is removed the ultraviolet light is turned off. Each time the lid is removed the BeagleBone triggers an external camera focused on the enclosure and records date and time and the ID of the smart badge added or removed on the image which is sent to the remote secure central server for user interface via a browser. Periodically the BeagleBone sends data accumulated from the smart badges to the remote secure central server with spooling of messages unsent for any reason for later transmission. In this example the authentication unit 160 is represented by a microphone to observe user voice commands, communicating voice information to the BeagleBone. There is a voice identification program in the BeagleBone which identifies authorized users and transmit an alarm if an identified or unidentified user extracts a badge associated with another.

As another mode of operation in place of the cover micro switch input to the BeagleBone this could be an output line to controls exposing only the badge of an authorized user, once an authorized user is identified. This could be done by, for example, having individual covers for each cradle releasable by the BeagleBone. Such an arrangement would avoid having the user touch, and possibly contaminate, any part of the enclosure other than the smart badge to be removed. If a smart badge is not removed a timeout can replace the releasable cradle cover which will resume sanitizing the smart badge not removed.

We claim:

1. A method of temporary storage of multiple smart badges in cradles in an enclosure, comprising
a. providing in said enclosure a charging means which replenishes the energy storage means of each said smart badge,
b. providing in said enclosure a communication controller with a means of communication between each said smart badge and said communication controller allowing the downloading of data from each said smart badge and/or exchange of programming and status information, and
c. providing in said communication controller a means of communications from said communication controller to systems outside said enclosure in a manner suitable for the communications link and destination.
whereby data stored on said smart badges can be selectively retrieved in a manner suitable for said smart badge during the charging of said smart badge and transmitted to said systems outside said enclosure.

2. The method of claim 1a wherein providing said charging means comprises providing inductive charging, providing charging through electrical contacts, or providing suitable light for photovoltaic cells within said smart badges.

3. The method of claim 1b wherein said communication controller is a processor-based programmable unit solely responsible for the accumulation, organization, storage, spooling and subsequent transmission of information from said smart badges to said outside world.

4. The method of claim 1b wherein providing said means of communication between each said smart badge and said enclosure comprises providing a communications link such as a visible or infrared communications link, a wireless communications link, a communications link through electrical contacts, or a combination of the enumerated communications links and provides an initialization of said smart badge before removal.

5. The method of claim 1c wherein said providing a means of communications from said enclosure to systems outside said enclosure comprises providing a communication link such as a wired or wireless Ethernet link, a wireless WiFi link, a wired computer link such as USB, or an IR communications link.

6. The method of claim 1 further comprising providing within said enclosure a means for disinfecting said smart badges.

7. The method of claim 6 wherein said means for disinfecting said smart badges comprises exposing said smart badges to a disinfectant solution in a safe manner or exposing said smart badges to a disinfecting ultraviolet light in a safe manner, or similar means of disinfection.

8. The method of claim 1 further comprising providing within said enclosure a means for identifying a person attempting to access said smart badges by means such as biometric characteristics, voice recognition, password entry or other identification means and either restrict access to said user to only an associated smart badge, to associate said accessed smart badge to said identified user, or raise a system alert if said identified user removes a smart badge not associated with him.

9. An apparatus for the temporary storage of multiple smart badges, comprising:
a. an enclosure for supporting in cradles multiple said smart badges,
b. electronics to provide within said enclosure energy in a form to recharge energy storage devices in each said smart badge,
c. electronics within said enclosure to communicate with each said smart badge to exchange information from said smart badge and/or provide status or programming information,
d. electronics within said enclosure to perform any required modification of said information exchanged with said smart badge and elements of said enclosure to a form meaningful to a designated outside system, and
e. electronics in said enclosure to enable said enclosure to communicate with said designated outside system in a manner suitable for the communications link to said designated outside system and the type of said designated outside system,
whereby said enclosure is capable of providing information in a meaningful form to said outside system while recharging said smart badge.

10. The electronics of claim 9b wherein said electronics to provide within said enclosure energy in a form to recharge energy storage devices in each said smart badge comprises electronics to provide inductive charging, charging through electrical contacts, or providing suitable light for photovoltaic cells within said smart badges or another form of energy transfer.

11. The electronics of claim 9c wherein electronics within said enclosure to communicate with each said smart badge comprises electronics within said enclosure providing a visible or infrared communications link, a wireless communications link, a communications link through electrical contacts, a combination of the enumerated communications links, or other similar communications link to each said smart badge.

12. The electronics of claim 9d wherein said electronics in said enclosure to enable said enclosure to communicate with said designated outside system comprises electronics to provide a communications link such as a wired or wireless Ethernet link, a wireless WiFi link, a wired computer link, or an IR communications link to enable said enclosure to communicate with said designated outside system.

13. The apparatus of claim 9 further comprising hardware and controls within said enclosure to accomplish disinfecting of said smart badges in a safe manner.

14. The apparatus of claim 13 wherein said hardware and controls within said enclosure comprises hardware and controls exposing said smart badges to a disinfectant solution or hardware and controls exposing said smart badges to a disinfecting ultraviolet light.

15. The apparatus of claim 9 further comprising electronics to identify by biometric identification, or other personal identification, who is accessing the enclosure and either restrict access to only an associated smart badge, reassign whichever smart badge is to the identified individual, or alarm the system if a smart badge is removed not associated with the identified individual.

16. The apparatus of claim 9 further comprising electronics to trigger a camera to take an image of an individual removing a smart badge and tagging said picture with the smart badge identification and time of removal.

17. The apparatus of claim 9 further comprising electronics providing for initializing said smart badge before removal.
